(19) United States
(12) Patent Application Publication
(10) Pub. No.: US 2010/0141523 A1
(43) Pub. Date: Jun. 10, 2010

(54) SATELLITE POSITIONING SYSTEM SIGNAL SEARCHING METHODS AND APPARATUSES

(75) Inventors: Wyatt Thomas Riley, Chesterbrook, PA (US); Michael James Wengler, Carlsbad, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/630,508

(22) Filed: Dec. 3, 2009

Related U.S. Application Data
(60) Provisional application No. 61/121,133, filed on Dec. 9, 2008.

(51) Int. Cl. G01S 19/24

(52) U.S. Cl. 342/357.15

(57) ABSTRACT

Methods and apparatuses are provided which may be enabled within and/or for use with a Satellite Positioning System (SPS) receiver and/or other like apparatuses or device(s) to perform a rapid search startup process.

### RELATED APPLICATION

This patent application claims benefit of and priority to co-pending U.S. Provisional Patent Application 61/121,133, filed Dec. 9, 2008, and titled “Method for Improving Time to First Fix in a Navigation System”, and which is incorporated in its entirety by reference herein.

### BACKGROUND

1. Field

The subject matter disclosed herein relates to electronic devices, and more particularly to methods and apparatuses for use in electronic devices that receive satellite positioning system (SPS) signals.

2. Information

Among the increasingly popular wireless technologies today are navigation systems and like configured devices and in particular those devices that acquire signals from a satellite positioning system (SPS) which may, for example, include the Global Positioning System (GPS) and/or one or more other like Global Navigation Satellite Systems (GNSSs), and/or regional navigation systems (e.g., Quasi-Zenith Satellite System (QZSS) over Japan, Indian Regional Navigational Satellite System (IRNSS) over India, Beidou over China, etc.). Based, at least in part, on acquired SPS signals, such devices may themselves and/or with the help of other devices estimate the current location and/or establish other positional/navigational information. For example, estimated pseudorange information, estimated geographical location, estimated altitude, and/or estimated speed may be determined, often with significant accuracy.

Before such a device may determine such information, an SPS receiver supporting the positioning process needs to acquire a sufficient number of SPS signals. As such, an SPS receiver needs to conduct some form of a startup process during which SPS signals are searched for and acquired. During certain example search processes, an SPS receiver may be enabled to perform waveform correlation and/or other like processes that allow for specific SPS signals to be identified within a received RF signal, which may also include noise and/or one or more other signals. To search for an SPS signal transmitted by a particular satellite within a received RF signal, an SPS receiver may be enabled to compare sampled waveform portions of the received RF signal with locally generated replica SPS signal waveforms (e.g., part or all of the PN code associated with the particular satellite). For example, a correlation process may test a plurality of code phase and Doppler hypotheses. The hypothesis testing is generally referred to as a search for the satellite, and once the relative code phase and Doppler for the particular signal is identified, the satellite is said to be acquired. After acquisition, a simpler tracking process may be implemented to update the code phase and Doppler for the satellite. Once acquired, information that is carried in the SPS signal may be accessed. For example, in the United States Global Positioning System (GPS), information in the navigation message can be accessed. This information can include satellite orbital information such as Ephemeris and almanac information, timing information, satellite health information, etc.

There may be several different startup processes which may be selectively employed depending on the situation/status of the device. Such startup processes tend to relate to the past usage of the device and the current communication environment. For example, a “cold” startup process may be employed if a device does not have significant information about the location and/or time at startup. For example, if the device has no information about its current location (e.g., it was powered off in San Francisco and powered on again in London without access to information about its new location), and/or if the device has no information about the current time (e.g., the device clock was powered off and did not have an alternate power source), it would have no idea which positioning satellites are in view. A cold start may occur if the device has never been fully initiated or has not been initiated for a given period of time, or for other reasons (e.g., suffered a memory discharge, or underwent a battery change, software upgrade, repair, etc.) may not be able to estimate a rough location and/or SPS time, or otherwise have enough information available to possibly narrow the list of SPS signals to search for. In existing cold start processes, a device may search for satellites in a sequential or random order, and a first satellite is acquired when the search reaches a satellite that happens to be in view and the strength of the signal from that satellite at the receiver is sufficient for acquisition. Accordingly, a “cold” startup process may take some time (e.g., several minutes or more) for a time-to-first-fix (TTFF) as the various SPS signals are searched for.

To the contrary, if a device is able to estimate a rough location and/or SPS time, or otherwise has enough information available, it may be possible to narrow the list of SPS signals to be searched. Such information may relate to previous usage (e.g., a previous position), may be input by a user, and/or may be provided over a communication link by one or more other devices. With such information, for example, a “warm” or “hot” startup process may be employed which may reduce the TTFF. Thus, with certain example “warm” or “hot” startup processes, the SPS receiver may be able to estimate or otherwise determine with some probability SPS satellites which may be overhead and from which SPS signals are more likely to be received. Consequently, a list of SPS signals to search for may be narrowed in some manner to concentrate on SPS signals transmitted by satellites believed to be in view, and more particularly to concentrate on SPS signals that have a greater expected signal strength (e.g. from satellites that are overhead).

### SUMMARY

In accordance with certain aspects, techniques are provided which may be implemented through various methods and apparatuses in a Satellite Positioning System (SPS) receiver and/or other like apparatuses or device(s) to perform a rapid search startup process using at least one search order based, at least in part, on estimated relative positions of SPS signal transmitting space vehicles (SVs). In certain situations, a rapid search startup process may significantly reduce time-to-first-fix (TTFF), for example, and/or provide other performance-related benefits.

In certain example implementations, a method may be implemented in initializing an SPS receiver by selectively searching for at least a first one of a plurality of SPS signals in a received RF signal according to an initial search order. Here, for example, the initial search order may be associated with the plurality of SPS signals transmitted from a corresponding plurality of SVs and based, at least in part, on an estimated relative position for each SV. The method may include, in response to identifying at least the first one of the plurality of SPS signals in the received RF signal (e.g., transmitted by a first SV), accessing a refined search order comprising at least a portion of the plurality of SPS signals that have not been searched. Here, for example, a refined search order may be based, at least in part, on an estimated relative position of the first SV. The method may include selectively searching for at least a second one of the plurality of SPS signals in the received RF signal according to such refined search order. In certain further example implementations, a method may also include establishing an initial search order, and/or a refined search order.

In certain example implementations, an estimated relative position may comprise an estimated relative position associated with one reference plane. Here, for example, a reference plane may comprise a longitudinal plane, and an estimated relative position may comprise an estimated relative longitude position.

In certain example implementations, a method may further include establishing an initial search order based, at least in part, on a plurality of different orbital planes associated with the plurality of SVs. In certain example implementations, a method may further include determining an estimated relative position for each of the plurality of SVs at a reference time using stored orbital information. Here, for example, a reference time may be substantially different from an SPS time. In certain examples, a reference time may be based, at least in part, on the stored orbital information. Stored orbital information may, for example, comprise dated almanac information associated with the SPS, dated ephemeris information associated with the SPS, and/or the like.

In certain example implementations, a method may further include determining an estimated relative position for each of the plurality of SVs at a reference time on a reference plane within a modeled reference frame. Here, for example, with such modeled reference frame, a rotational rate associated with Earth may substantially match an average orbital period associated with at least a portion of the plurality of SVs.

In certain example implementations, a method may further include arranging or otherwise associating a plurality of SVs into a plurality of SV groups based on the estimated relative positions, such that an initial search order specifies an initial sequential searching priority based, at least in part, on the plurality of SV groups. Here, for example, at least two SVs within at least one of the plurality of SV groups may be associated with different orbital planes.

In certain example implementations, estimated relative positions of a plurality of SVs may be opertively considered to be part of a closed circular set of values such that an initial search order may specify an initial sequential searching priority based, at least in part, on a binary search of such closed circular set of values.

In certain example implementations, a refined search order may specify a refined sequential searching priority based, at least in part, on estimated distances from a first SV to each SV associated within a portion of the plurality of SPS signals that have not been searched for. Here, for example, an estimated distance may be based, at least in part, on one or more corresponding estimated relative positions.

In certain example implementations, a method may also include acquiring a first one of the plurality of SPS signals, determining an SPS time based, at least in part, on the first one of the SPS signals, and updating an estimated relative position for each of at least a portion of the plurality of SVs at the SPS time using stored or otherwise available orbital information.

In certain example implementations, a method may also include acquiring a first one of the plurality of SPS signals, and updating at least a portion of stored orbital information based, at least in part, on the first one of the plurality of SPS signals.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an exemplary signaling environment that includes a device having at least one SPS receiver enabled to perform a rapid search startup process, in accordance with an implementation.

FIG. 2 is a schematic block diagram illustrating certain features of an exemplary device, for example as in FIG. 1, enabled to perform a rapid search startup process using at least one search order that is based, at least in part, on estimated relative positions of SPS signal transmitting space vehicles (SVs), in accordance with an implementation.

FIG. 3 is a schematic block diagram illustrating certain features of an exemplary device, for example as in FIG. 2, having a memory within which at least one search order is stored, in accordance with an implementation.

FIG. 4 is a schematic block diagram illustrating certain features of an exemplary RF signal received by a device, for example as in FIG. 2, in accordance with an implementation.

FIG. 5 is a flow diagram illustrating an exemplary process for performing a rapid search startup process that may, for example, be implemented in the device of

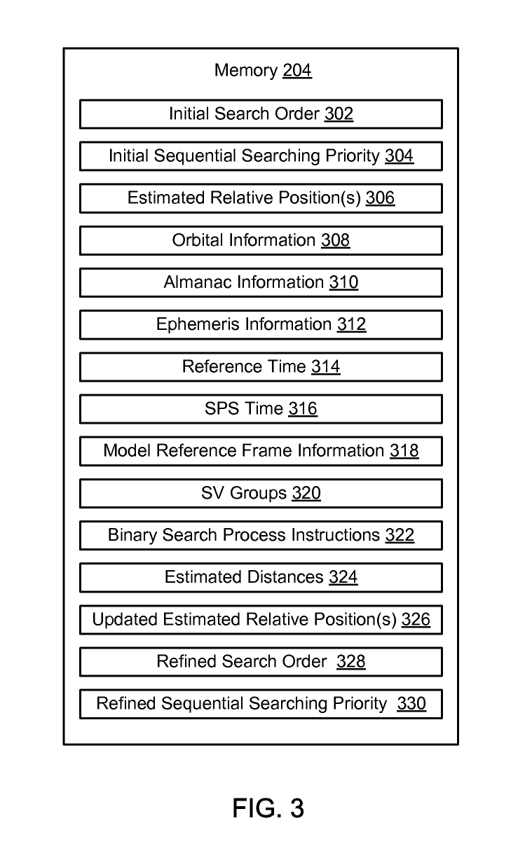

FIG. 2, in accordance with an implementation.

FIG. 6 is an illustrative graph showing estimated relative longitude and latitude positions for several example SVs within an exemplary reference frame, in accordance with an implementation.

FIG. 7 is an illustrative diagram showing estimated relative positions for several example SVs associated with a reference plane, in accordance with an implementation.

### DETAILED DESCRIPTION

Non-limiting and non-exhaustive aspects are described with reference to the following figures, wherein like reference numerals refer to like parts throughout the various figures unless otherwise specified.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

As noted above, a position fix can be obtained more quickly when position and time information is available. If coarse position and current time are known, the device can access satellite orbit information (such as almanac) to determine which satellites should be in view from the coarse position at the current time. If coarse position and time are known accurately enough, the device may be able to use estimated pseudoranges to narrow the search space for the satellites expected to be in view (the range of possible code phases/Dopplers of the received signal from particular satellites), which reduces the TTFF even more.

However, when a location operation is initiated on a device that does not know its coarse position and/or reasonably accurate time, acquiring satellites can be time-consuming, since the device does not know which satellites to look for, even if it has access to satellite orbital information. Some example methods and apparatuses are described herein which may be enabled within and/or for use with at least one Satellite Positioning System (SPS) receiver and/or other like apparatuses or device(s) to perform a rapid search startup process using at least one search order based, at least in part, on estimated relative positions of SPS signal transmitting space vehicles (SVs) to one another. In certain situations, a rapid search startup process may significantly reduce average time-to-first-fix (TTFF), for example, and/or provide other performance-related benefits.

By way of example, as described in greater detail herein an SPS receiver may be initialized using a rapid startup process in which an initial search order is established (and/or otherwise accessed from memory). An initial search order may, for example, specify a sequential searching priority to be followed while searching for SPS signals transmitted by the SVs. Such an initial search order may, for example, be based at least in part on estimated relative positions of the SVs. Note that the relative positions need not be known to high accuracy for the current techniques to provide a benefit in average TTFF over existing techniques using random or sequential search orders. An SPS receiver and/or device that it may be part of may selectively search for at least a first one of the SPS signals in a received RF signal according to the initial search order. In response to finding at least the first one of the SPS signals (e.g., transmitted by a first SV), a refined search order may be established (and/or otherwise accessed from memory). The refined search order may then be used during further searching for SPS signals. The refined search order may, for example, be based at least in part on an estimated relative position of the first SV. For example, the refined search order may specify a refined sequential searching priority which is followed while searching for additional SPS signals transmitted by SVs that may be nearby the first SV.

The current techniques can provide an important benefit in a cold start scenario. Currently, without a priori position and/or time information to aid in the search for satellites, a random or sequential search is typically used. If there are enough satellites in view for a position fix, either random or sequential search will eventually lead to a fix; however, the TTFF may be substantial. The current techniques can reduce the average TTFF even if no information is available about the current position of the receiver and/or the time is not precisely known.

In the example of the GPS constellation, although the relative positions of the satellites vary with time, the current techniques can be used to generate a search order based on a degree of predictability in relative longitudinal relationships among the satellites (described in more detail below). In effect, using the relative longitudinal distribution of satellites to establish a search order allows the search to cover a large number of possible receiver locations in a short time (or equivalently, cover a large number of possible times). In certain example implementations, estimated relative positions of satellite vehicles may be represented with respect to a reference plane. By way of example but not limitation, a longitudinal plane may be used as a reference plane, and estimated relative positions may represent estimated relative longitude positions for the SVs at a reference time. In certain example implementations, a search order may be based, at least in part, on a plurality of different orbital planes and/or other like patterns associated with orbiting SVs that indicate the relative positions of the satellites.

Estimated relative positions of the SVs may, for example, be determined for a reference time using stored orbital information. A reference time may be different from an SPS time and may be based, at least in part, on stored orbital information. Stored orbital information may, for example, include almanac information, ephemeris information, and/or the like which is associated with the SPS, GNSS, and/or SV. That is, even if accurate SPS (e.g., standard GPS) time is not known, the distribution of the satellites at a selected reference time can be determined using orbital information such as almanac, and a search order can be established using the determined distribution.

With regard to certain exemplary devices, an SPS may include a system of transmitters positioned to enable entities to determine their location on or above the Earth based, at least in part, on signals received from the transmitters. Such a transmitter may transmit an SPS signal marked with a repeating pseudo-random noise (PN) code of a set number of chips and may be located on ground based control stations, user equipment and/or space vehicles. A “space vehicle” (SV) as referred to herein relates to an object that is located above the Earth's surface and is capable of transmitting signals used for positioning techniques. In one particular example, such an SV may include a geosynchronous or geostationary satellite. Alternatively, an SV may include a satellite traveling in an orbit and moving relative to a stationary position on the Earth. However, these are merely examples of SVs and claimed subject matter is not limited in these respects.

In a particular example, such transmitters may be located on SVs such as Earth orbiting satellites. For example, a satellite in a constellation of a GNSS such as Global Positioning System (GPS), Galileo, GLONASS, Compass, and/or the like may transmit a signal marked with a PN code, where signals from one SV are distinguishable from signals from a different SV (e.g., by virtue of different PN codes as in GPS, by virtue of different frequencies as in the GLONASS system, or otherwise distinguishable). To estimate a location at a receiver, a device may be enabled to determine pseudorange measurements to SVs “in view” of the receiver using well known techniques based, at least in part, on detections of PN codes in signals received from the SVs.

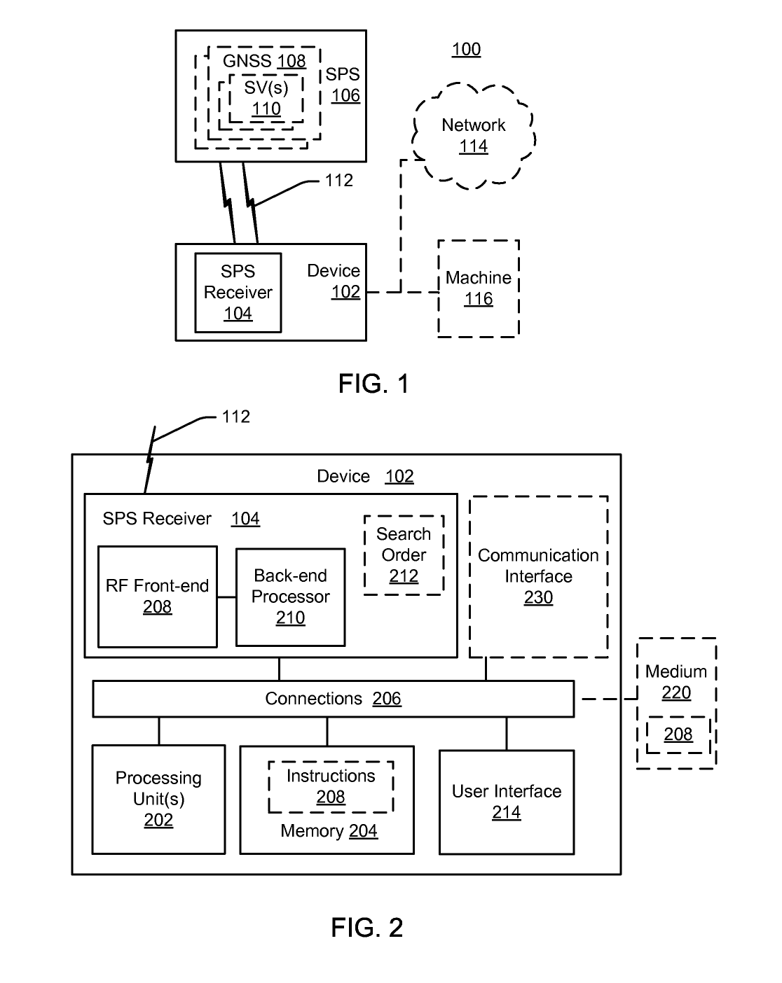

FIG. 1 is a block diagram illustrating an environment 100 that may include various computing and communication resources. This example implementation may be enabled to provide at least some form of navigation/positioning services in accordance with certain exemplary implementations of present description. This example implementation may also be enabled to provide at least some form of communication services in accordance with certain further exemplary implementations of present description.

As for navigation services, for example, as shown in FIG. 1 an SPS 106 may include one or more GNSS 108, each of which may include a different plurality of SVs 110 that may transmit different SPS signals 112 that may be received and acquired by a device 102 having at least one SPS receiver 104.

By way of example but not limitation, device 102 may include a mobile device such as a cellular phone, a smart phone, a personal digital assistant, a portable computing device, a navigation unit, and/or the like or any combination thereof In other example implementations, device 102 may take the form of a machine that is mobile or stationary. In still other example implementations, device 102 may take the form of one or more integrated circuits, circuit boards, and/or the like that may be operatively enabled for use in another device. Indeed, in certain example implementations, device 102 may take the form of an SPS receiver 104.

In certain implementations, one or more other machines 116 may be provided and enabled to provide information to device 102. Such information may include various types of data and/or instructions that may be of use by device 102. In certain example implementations, such data and/or instructions may include or otherwise be of support in establishing one or more initial search orders and/or one or more refined search orders that may be based, at least in part, estimated relative positions of a plurality of SVs 110.

In certain implementations environment 100 may further include various computing and communication resources enabled to provide communication and/or other information processing services with respect to device 102. Thus, for example, environment 100 may be representative of any system(s) or a portion thereof that may include at least one device 102 enabled to transmit and/or receive signals to/from at least one communication network 114.

Device 102 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example.

Techniques described herein may be used with an “SPS” that includes any one of several satellite systems and/or combinations of satellite systems.

In accordance with certain aspects, some exemplary methods and apparatuses will now be described, which may be implemented in one or more devices, such as device 102, to provide a rapid search startup process using at least one search order that may be based, at least in part, on estimated relative positions of SPS signal transmitting SVs.

As illustrated in the exemplary block diagram of FIG. 2, in certain example implementations, device 102 may include an SPS receiver 104 enabled to receive an RF signal that includes at least one SPS signal 112. SPS receiver 104 may include, for example, an RF front-end circuit 208 coupled to a back-end processor 210, one or more of which may be response to at least one search order 212 to support a rapid search startup process. As described in greater detail below, search order 212 may include an initial search order and/or one or more refined search orders, of which all or portions may be accessed and/or established by device 102.

SPS receiver 102 may include, for example, one or more processing units 202 that may be enabled to initiate and/or otherwise support a rapid search startup process. For example, processing unit(s) 202 may be enabled to selectively initiate a rapid search startup process, and/or access information stored in memory 204 as needed to establish search order 212. In certain example implementations, processing unit(s) 202 may be responsive to instructions 208, which may be stored in memory 204.

As illustrated in FIG. 2 an article of manufacture represented here by a computer readable medium 220 may be provided and accessed by processing unit 202, for example. As such, in certain example implementations, the methods and/or apparatuses may take the form in whole or part of a computer readable medium 220 that may include computer implementable instructions 208 stored thereon, which if executed by at least one processing unit or other like circuitry enable the processing unit(s) 202 and/or the other like circuitry to perform all or portions of a rapid search startup process as presented in the examples herein.

Processing unit(s) 202 may be implemented in hardware or a combination of hardware and software. Processing unit(s) 202 may be representative of one or more circuits configurable to perform at least a portion of a data computing procedure or process. By way of example but not limitation, processing unit(s) 202 may include one or more processors, controllers, microprocessors, microcontrollers, application specific integrated circuits, digital signal processors, programmable logic devices, field programmable gate arrays, and the like, or any combination thereof

Memory 204 may be representative of any data storage mechanism. Memory 204 may include, for example, a primary memory and/or a secondary memory. Primary memory may include, for example, a random access memory, read only memory, etc. While illustrated in this example as being separate from processing unit(s) 202, it should be understood that all or part of a primary memory may be provided within or otherwise co-located/coupled with processing unit(s) 202. Secondary memory may include, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, computer readable medium 220.

As further illustrated in FIG. 2, device 102 may include one or more connections 206 (e.g., buses, lines, conductors, fibers, etc.) to operatively couple the various circuits together, and a user interface 214 (e.g., display, touch screen, keypad, buttons, knobs, speakers, etc.) to receive user input and/or provide information to the user. Device 102 may, in certain example implementations, also include a communication interface 230 (e.g., wired or wireless transceiver, modem, etc.) to allow for one-way or two-way communication with one or more other devices (not shown).

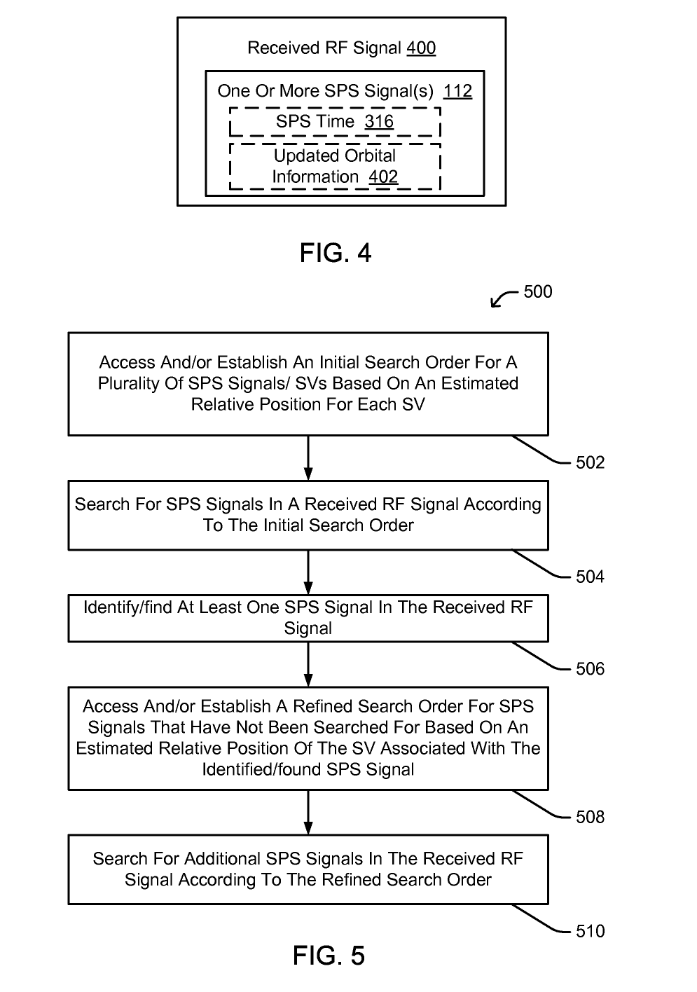

Attention is drawn next to FIG. 3, which is a block diagram further illustrating certain example information which may be stored, at times, in memory 204 and/or otherwise accessed by circuitry within device 102, at times, to support and/or implement a rapid search startup process.

For example, memory 204 may at times have stored therein at least one initial search order 302 which may specify an initial sequential searching priority 304. All or part of initial search order 302 may, for example, be established and/or otherwise provided to memory 204 by processing unit(s) 202. Similarly, for example, memory 204 may at times have stored therein at least one refined search order 328 which may specify a refined sequential searching priority 330. All or part of refined search order 328 may, for example, be established and/or otherwise provided to memory 204 by processing unit(s) 202.

For example, memory 204 may at times have stored therein one or more estimated relative position(s) 306, wherein each estimated relative position 306 may be associated with a specific SV and hence SPS signal as transmitted thereby. All or part of the one or more estimated relative position(s) 306 may, for example, be established and/or otherwise provided to memory 204 by processing unit(s) 202. For example, processing unit(s) 202 may establish at least a portion of an estimated relative position 306 based, at least in part, on orbital information 308. In certain implementations, orbital information 308 may include almanac information 310 (which may be dated or updated), ephemeris information 312 (which may be dated or updated), and/or the like. Processing unit(s) 202 may, for example, establish at least a portion of an estimated relative position 306 based, at least in part, on a reference time 314. As described in greater detail below, reference time 314 may or may not match an SPS time 316 when a rapid search startup process is first initiated. Processing unit(s) 202 may, for example, establish at least a portion of an estimated relative position 306 based, at least in part, on model reference frame information 318.

As described in greater detail below, for example, estimated relative position(s) 306 for the SVs may be mathematically distributed with respect to a reference plane and/or otherwise modeled/related in some manner such that there may be estimated distances 324 there between, which at times may be stored in memory 204. In certain implementations, an SV may be associated with one or more SV group(s) 320 during a rapid search startup process, for example, based on estimated relative position 305 and/or estimated distance 324. In certain example implementations, binary search process instructions 322 may be stored in memory 204 and used during a rapid search startup process to establish initial search order 302.

In certain example implementations, it may be possible during a rapid search startup process for processing unit(s) 202 to establish and/or otherwise provide to memory 204 one or more updated estimated relative positions 326 for one or more SVs.

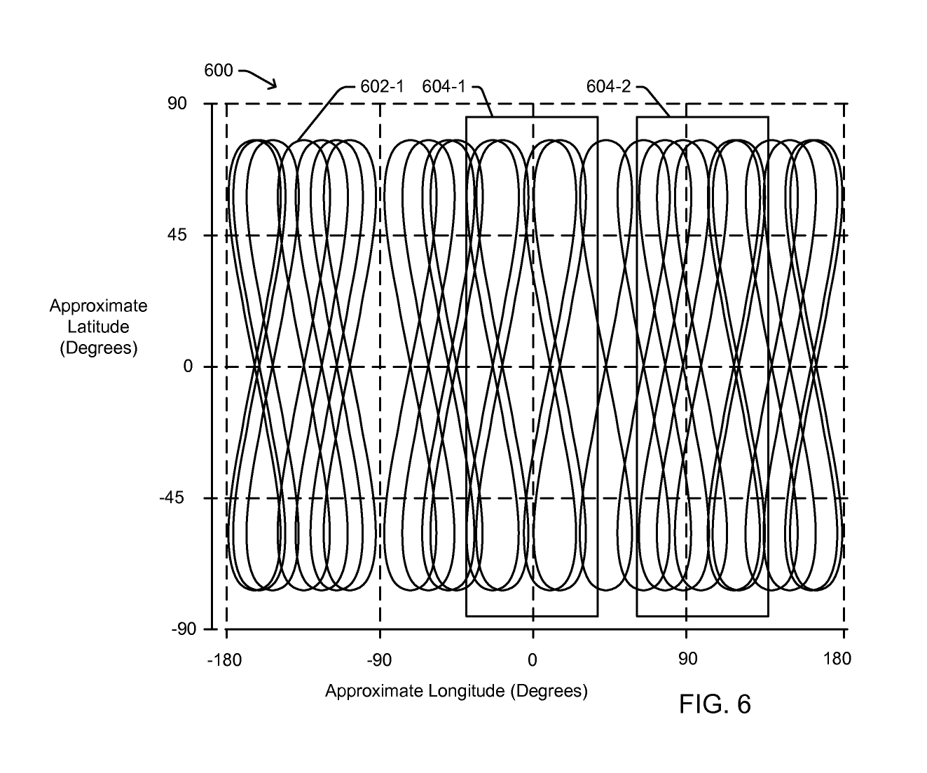

Reference is made next to FIG. 4, which is a block diagram illustrating certain features of an exemplary RF signal 400 that may be received by device 102 and/or SPS receiver 104. RF signal 400 may include, for example, one or more SPS signals 112, which may identify an SPS time 316 and include (updated) orbital information 402, one or more of which may be useful to processing unit(s) 202 and/or SPS receiver 104 during a rapid search startup process.

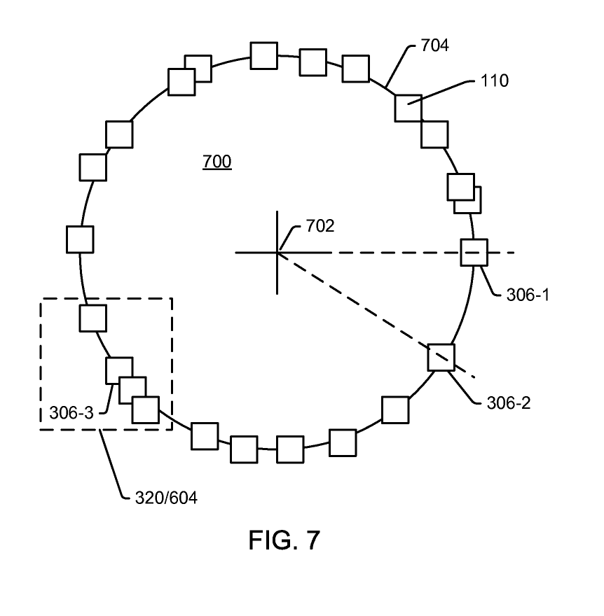

Reference is made next to FIG. 5, which is a flow diagram illustrating an exemplary rapid search startup process 500 that may, for example, be implemented in the device of FIG. 2.

At block 502, initial search order 302 may be accessed and/or established for use in searching for SPS signals 112 transmitted by SVs 110. Initial search order 302 may be based, at least in part, on an estimated relative position 306 for each SV 110. At block 504, a search for SPS signals 112 in a received RF signal 400 may be conducted according to initial search order 302. At block 506, as a result of the search at block 504 at least one SPS signal 112 may be identified (e.g., found) in received RF signal 400. At block 508, a refined search order 328 for SPS signals 112 may be accessed and/or established. For example, refined search order 328 may be established for SPS signals 112 that have not yet been searched for based, at least in part, on estimated relative position of the SV associated with the SPS signal identified at block 506. For example, refined search order 328 may be established for SPS signals 112 transmitted by SVs 110 having estimated relative positions within a threshold distance of the SV associated with the SPS signal identified at block 506. For example, refined search order 328 may be established for SPS signals 112 transmitted by SVs 110 associated with an SV group that includes the SV associated with the SPS signal identified at block 506. At block 510, a search for additional SPS signals 110 in received RF signal 400 may be conducted according to refined search order 328.

While some additional example rapid search startup processes are described in greater detail below, it may be useful to consider some graphical illustrations beforehand, which illustrate that GNSS constellations may have certain orbital patterns that may be exploited to establish at least an initial search order that may reduce average TTFF by taking into account such patterns and/or the estimated relative positions that such patterns produce with regard to the SVs. While the following examples are illustrated with respect to GPS, claimed subject matter is not necessarily limited. Indeed, as used herein an “SPS” may include one or more GNSS, and/or the like.

Attention is drawn next to FIG. 6, which is an illustrative graph showing estimated relative longitude and latitude positions for several example SVs, as modeled within an exemplary reference frame 600. With modeled reference frame 600, a rotational rate associated with Earth substantially matches an average orbital period associated with the SVs. Thus, for example, here the rotational rate of the Earth has been increased to match an average GPS orbital period (e.g., the GPS SVs are modeled as having geosynchronous orbits). This modeling technique is shown here to illustrate that when considered within such reference frame each SV's orbit forms a plot having a “figure eight” like shape with a length that extends along much of the y-axis (approximate latitude in degrees) and a width that is confined to a portion of the x-axis (approximate longitude in degrees). For example, one SV produced the plot 602-1, which appears centered between approximately −180 degrees and approximately −90 degrees on the x-axis with a width of approximately 30 degrees at the lobes, and which appears centered between approximately −80 degrees and approximately 80 degrees on the y-axis with a length of about 160 degrees.

It should be kept in mind, however, that FIG. 6 is presented as an illustration only and is not drawn to scale and/or otherwise intended to be specifically accurate. What FIG. 6 does show in a graphical manner, however, is that regardless of the current SPS time, as modeled here, there should be a subset of satellites that may be considered to likely be “overhead” of a device and therefore the SPS signals from these SVs may be more likely to be acquired by the device. For example, SV groups 604-1 and 604-2 are illustrated as each having associated with it a different subset of SVs.

Thus, as illustrated by the example in FIG. 6, there may be one or more potential patterns associated with one or more GNSS constellations that may be exploited while establishing an initial search order and/or refined search order. Here, for example, an East-West or longitudinal pattern has been illustrated for GPS satellites. As such, it may be possible to establish several SV groups each of which may cover a portion of a reference (here, longitudinal) plane. The SV groups may be uniform or non-uniform in size/shape with regard to the reference plane and may be mutually exclusive or may overlap. The SV groups may be associated with the same number of SVs or differing numbers of SVs.

As part of an initial search order, a binary search or other like process may be employed to prioritize SPS signals to search for based, at least in part on estimated reference positions of the transmitting SVs. As such, in certain implementations, an initial search order may be established based on SV groups, which may be based, at least in part on estimated reference positions of the transmitting SVs.

Those skilled in the art will recognize that, if current SPS time were known then, depending on the age of the orbital information that is used to generate the estimated SV positions, it may also be possible to estimate a relative latitudinal position for each SV. Thus, in certain implementations, a longitudinal or other like reference plane may be adjusted in some manner based on estimate latitudinal position information and/or the like. That is, even without knowing time, a search order for particular satellites can be established that allows for reduced average TTFF by searching satellites that are relatively widely distributed over the possible locations of the receiver to get a first acquisition. However, if time is known, the search order can be improved using estimated relative latitudinal information. In one example, knowing the approximate y-value for each of the satellites illustrated in FIG. 6 can improve the initial satellite search order by better distributing the initial search to more quickly acquire a first satellite, and/or may improve the revised search order by improving the groupings/estimated relative positions of other satellites after at least one satellite has been acquired.

Reference is made next to FIG. 7, which is an illustrative diagram showing estimated relative positions for several example SVs 110 (represented as small squares) on a reference plane 700 (shown here as a circle on the printed page). With regard to reference plane 700 the estimated relative positions 306 of the SVs appear on a closed circular set of values on line 704. For example, the closed circular set may include 0-359 degrees. Here, estimated relative positions 306-1 and 306-2 are labeled, and have a relative distance there between that may be estimated as measured along line 704 and/or angularly measured from point 702 (e.g., an Earth centered point). Also, as illustrated in FIG. 7, an SV group 320/604 may be specified, here for example, SVs within a threshold range of estimated relative position 306-3 may be associated with an SV group.

Thus, again there appears a potential pattern in these examples that may be exploited when establishing an initial search order and/or refined search order. Still other potential patterns may be identified, for example, based on the orbital planes and/or slots of the SVs and from which different SV groups may be defined. The following sections illustrate some examples in greater detail and present two implementations, one where SPS time may not be known to the device and one wherein SPS time may be known to the device.

The following sections illustrate some further example techniques that may be implemented as part of or to otherwise support a rapid search startup process. Such techniques may, for example, be implemented to access stored orbital information and based, at least in part thereon, establish or otherwise determine: one or more estimated relative positions of SVs; one or more SV groups; a reference time; a reference plane; a reference frame; an initial search order; an initial sequential searching priority; and/or a refined search order. Such techniques may be implemented in devices that are aware of or unaware of the current SPS time. Such techniques may be implemented in devices that may be aware or unaware of its current or previous position.

With such in mind, the following example techniques may be useful if SPS time and a current or even rough position of the device are unknown. Here, in this example, stored orbital information may be accessed from memory. For example, an SPS almanac (which may be significantly dated) may have been stored in memory at some stage during manufacture of the device. In certain implementations, such (dated) SPS almanac may be used. In other implementations, if a “newer” SPS almanac may be available then such may be loaded into memory.

To recapitulate, in certain example implementations estimated relative positions of the SVs may be established at a reference time with respect to a reference plane based, at least in part, on the stored orbital information. An initial search order (and/or refined search order) may be established based, at least in part, on the estimated relative positions.

In certain example implementations, a reference time may be chosen in a variety of ways. For example, a reference time may simply be chosen as it relates to the available Almanac information. In other implementations, a reference time may be chosen in a statistical or other like mathematical manner. For example, a reference time may be chosen as the median or mode of the TOA (time of almanac) values from the Almanac entries available.

In an example GPS implementation the estimated relative positions of SVs at such reference time may be associated with a longitudinal reference plane. Here, for example, using the almanac information for a given SV, then let: Ωₖ=Longitude of Right Ascension at Reference Time (in Radians), and Lₖ=Longitude at Reference Time (in Radians). A Longitude of Right Ascension at reference time may be defined as: Ωₖ=mod((Ω₀+(\dot{Ω}−\dot{Ω}ₑ)tₖ−\dot{Ω}ₑtₒₐ, 2π), where Ω₀ is the Longitude of Right Ascension at the beginning of the almanac week (from the SPS almanac), and \dot{Ω}ₑ is the ICD-GPS-200 sidereal rotation rate of the Earth=7.2921151467e-5 rad/sec, and \dot{Ω} is the nominal nodal regression rate of

$$G P S orbits = {\dot{Ω}}_{e} - \frac{2 π - \frac{.1255}{7}}{24 * 60 * 60} ( rad \text{/} sec ) ,$$

and tₖ is the reference time, in seconds of a GPS week, compensated for week rollovers (e.g., if the reference week (wₖ) is not the same as the almanac week (wₒₐ), tₖ should be increased by 604800*(wₖ−wₒₐ)), and tₒₐ is the time-of-almanac, from the Almanac.

Continuing with this GPS example, the Longitude at Reference Time (Lₖ) may be defined as: Lₖ=mod((Ωₖ+ω+M₀+2π(tₖ−tₒₐ)/T),2π), where Ωₖ is the Longitude of Right Ascension at reference time (from above), ω is the Argument of Perigee (from the Almanac), M₀ is the Mean Anomaly (from the SPS almanac), and T is the nominal GPS orbital period=86154.4 seconds (e.g., just less than ½ a sidereal day, so that ground tracks repeat even with nodal regression).

Thus, in the GPS example above, a Longitude at Reference Time (Lₖ) may be determined for each SV and serve as an estimated relative position. In certain implementations, other types of stored orbital information such as, for example, Ephemeris may be used in addition to or instead of an SPS almanac.

Continuing with the GPS example, an initial search order may be established based, at least in part on the estimated relative position. By way of example, Table 1 below illustrates some example estimated relative positions for certain GPS SVs, where the PRN is a number indicating the PN code used for that particular satellite.

TABLE 1

| SV PRN | Estimated Relative Position (Longitude in Degrees) |
|---|---|
| 5 | −156 |
| 12 | −153 |
| 9 | −145 |
| 26 | −127 |
| 29 | −117 |
| 24 | −108 |
| 10 | −107 |
| 2 | −99 |
| 4 | −64 |
| 17 | −54 |
| 28 | −42 |
| 8 | −37 |
| 27 | −15 |
| 13 | −10 |
| 23 | 18 |
| 20 | 19 |
| 11 | 24 |
| 19 | 52 |
| 3 | 73 |
| 16 | 86 |
| 1 | 87 |
| 25 | 96 |
| 31 | 106 |
| 14 | 126 |
| 22 | 129 |
| 7 | 148 |
| 21 | 159 |
| 18 | 161 |
| 6 | 173 |
| 30 | 175 |

Table 1 is ordered based on the estimated relative positions of the SVs. This is a circular list in that SV PRN 5 at the top of the list is in between SV PRN 12 and SV PRN 30.

In certain example implementations, an initial search order may be established based on a binary search or other like technique which considers the reference plane and estimated relative positions of the SVs distributed thereon. For example, with regard to Table 1 the 0-359 degrees of longitudinal plane may be iteratively divided as follows (in degrees): −180, 0, −90, 90, −135, 45, −45, 135, etc., and an initial search order established by selecting an SV having an estimated relative position that is closest to the selected positions. Thus, with regard to the example sequence above and Table 1, an initial search order may specify a priority of SPS signals to search for as (by SV PRN): 29, 25, 2, 16, 30, 19, 28, 22, 5, 13, 10, 6, 15, 11, 8, 14, 24, 7, 26, 31, 9, 20, 17, 21, 18, 23, 4, 3, 12, 27. Thus, in this example, a device may first search for an SPS signal transmitted by SV PRN 29, and if not found, then search for an SPS signal transmitted by SV PRN 25, and if not found, then search for an SPS signal transmitted by SV PRN 2, and so on.

In other example implementations, an initial search order may be established based on SV groups. For example, 0-359 degrees of longitudinal plane may be divided into portions of 30 degrees and a binary search or other like technique may be employed to order the SV groups and an SV in each group may be selected and its transmitted SPS signal searched for (if not already searched for). Such technique may be repeated so that all of the SPS signals are prioritized in the initial search order.

If one or more SPS signals have been found, a refined search order may be established. In certain implementations, for example, an SPS signal may be determined to be “found” if it is acquired. In certain implementations, for example, an SPS signal may be determined to be “found” if it is acquired and if there exists stored orbital information associated with it. Thus, there may be implementations in which an SPS signal may be acquired but not deemed to be “found” since there not any or at least an adequate amount of stored orbital information associated with it.

In certain example implementations for each “found” SV (with an adequate amount of stored orbital information available), a difference between a Longitude at Reference Time of the found-SV and another SV (also with an adequate amount of stored orbital information available) may be determined to establish an estimated longitudinal separation between these two SVs. Such determination may include, for example, taking the absolute value and possibly accounting for 2π rollovers (e.g., if x>π, x=2π−x) to establish an Absolute Longitudinal Separation between these two SVs.

A refined search order may be established to prioritize searching for SPS signals transmitted by SVs based on their distance from the SV whose SPS signal has been found. Of course, such refined search order may skip over SPS signals that have already been searched for but not found or otherwise deemed to be un-acquirable. In certain implementations, it may be possible at some point, for example, if current SPS time becomes known and/or updated orbital information is received, to determine updated estimated relative positions for one or more SVs whose transmitted SPS signals have not yet been found or acquired.

If current SPS time is already known or subsequently determined, then the SPS time may be used as or to otherwise adjust the reference time. For example, with SPS time and stored orbital information SVs may be propagated in their orbits from reference time to the current SPS time using one or more simple models as are well known.

In other example implementations, an initial search order may be pre-established and provided to a device for storage within a memory therein. Thus, for example, estimated relative positions of the SVs may be determined off-line using one or more supporting machines that may be enabled to provide the initial search order to a device. Thus, such supporting machine may implement the same or similar techniques as might the device (e.g., as provided in the examples above) to establish estimated relative positions at a reference time.

Similarly, in certain other example implementations, one or more refined search orders may be pre-established and provided to a device for storage within a memory therein. Thus, for example, a refined search order may be provided for each SV group or nearby SV groups such that if one or more of the SPS signals transmitted by one or more of the SV in an SV group and/or nearby SV group (e.g., overlapping, adjacent, etc.) is “found” then a refined search order associated therewith may be selected and used for additional searching.

As previously mentioned, the examples provided herein may be enabled for use with a device that acquires SPS signals from one GNSS or from multiple different GNSS. Those skilled in the art will recognize given these examples that, for example, such techniques may be enabled to support one or more differing types of SV orbits, SV constellations, stored orbital information, SPS times, and/or the like. Thus, example initial search orders and/or refined search orders may be associated with one or more GNSS, and/or portions thereof Where applicable a common reference time, reference plane, and/or reference frame may be employed for multiple GNSS.

Methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In this detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the detailed description have been presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method for use in initializing a satellite positioning system (SPS) receiver, the method comprising:
selectively searching for at least a first one of a plurality of SPS signals in a received RF signal according to an initial search order, said initial search order being associated with said plurality of SPS signals transmitted from a corresponding plurality of space vehicles (SVs), said initial search order being based, at least in part, on an estimated relative position for each SV;
in response to identifying at least said first one of said plurality of SPS signals in said received RF signal, said first one of said plurality of SPS signals being transmitted by a first SV, accessing a refined search order comprising at least a portion of said plurality of SPS signals that have not been searched, said refined search order being based, at least in part, on an estimated relative position of said first SV; and
selectively searching for at least a second one of said plurality of SPS signals in said received RF signal according to said refined search order.

2. The method as recited in claim 1, further comprising:
establishing at least one of: said initial search order, and/or said refined search order.

3. The method as recited in claim 1, wherein each said estimated relative position comprises an estimated relative position associated with one reference plane.

4. The method as recited in claim 3, wherein said one reference plane comprises a longitudinal plane.

5. The method as recited in claim 1, wherein each said estimated relative position comprises an estimated relative longitude position.

6. The method as recited in claim 2, further comprising:
establishing said initial search order based, at least in part, on a plurality of different orbital planes associated with said plurality of SVs.

7. The method as recited in claim 2, further comprising:
determining said estimated relative position for each of said plurality of SVs at a reference time using stored orbital information.

8. The method as recited in claim 7, wherein said reference time is substantially different from an SPS time.

9. The method as recited in claim 7, wherein said reference time is based, at least in part, on said stored orbital information.

10. The method as recited in claim 7, wherein said stored orbital information comprises dated almanac information associated with said SPS.

11. The method as recited in claim 7, wherein said stored orbital information comprises dated ephemeris information associated with said SPS.

12. The method as recited in claim 7, wherein determining said estimated relative position for each of said plurality of SVs further comprises:
determining said estimated relative position for each of said plurality of SVs at said reference time on a reference plane within a modeled reference frame.

13. The method as recited in claim 12, wherein with said modeled reference frame a rotational rate associated with Earth substantially matches an average orbital period associated with at least a portion of said plurality of SVs.

14. The method as recited in claim 12, wherein establishing said initial search order for said plurality of SPS signals further comprises:
arranging said plurality of SVs into a plurality of SV groups based on said estimated relative positions, and wherein said initial search order specifies an initial sequential searching priority based, at least in part, on said plurality of SV groups.

15. The method as recited in claim 14, wherein at least two of said SVs within at least one of said plurality of SV groups are associated with different orbital planes.

16. The method as recited in claim 1, wherein said estimated relative positions of said plurality of SVs are part of a closed circular set of values and said initial search order specifies an initial sequential searching priority based, at least in part, on a binary search of said closed circular set of values.

17. The method as recited in claim 1, wherein said refined search order specifies a refined sequential searching priority based, at least in part, on estimated distances from said first SV to each SV associated within said portion of said plurality of SPS signals that have not been searched for.

18. The method as recited in claim 17, wherein said estimated distances are based, at least in part, on said corresponding estimated relative positions.

19. The method as recited in claim 1, further comprising:
acquiring said first one of said plurality of SPS signals;
determining an SPS time based, at least in part, on said first one of said SPS signals; and
updating said estimated relative position for each of at least a portion of said plurality of SVs at said SPS time using said stored orbital information.

20. The method as recited in claim 1, further comprising:
acquiring said first one of said plurality of SPS signals; and
updating at least a portion of said stored orbital information based, at least in part, on said first one of said plurality of SPS signals.

21. The method as recited in claim 1, wherein said SPS comprises one or more Global Navigation Satellite Systems (GNSSs).

22. An apparatus comprising:
a satellite positioning system (SPS) receiver;
memory having stored therein an initial search order for a plurality of SPS signals transmitted from a corresponding plurality of space vehicles (SVs), said initial search order being based, at least in part, on an estimated relative position for each SV; and
at least one processing unit coupled to said SPS receiver and said memory, said at least one processing unit to signal said SPS receiver to:
selectively initiate a search for at least a first one of said plurality of SPS signals in a received RF signal according to said initial search order, and in response to at least identifying at least said first one of said plurality of SPS signals in said received RF signal, said first one of said plurality of SPS signals being transmitted by a first SV,
access a refined search order comprising at least a portion of said plurality of SPS signals that have not been searched for, said refined search order being based, at least in part, on an estimated relative position of said first SV, and
selectively initiate a search for at least a second one of said plurality of SPS signals in said received RF signal according to said refined search order.

23. The apparatus as recited in claim 22, wherein said at least one processing unit establishes at least one of: said initial search order, and/or said refined search order.

24. The apparatus as recited in claim 22, wherein each said estimated relative position comprises an estimated relative position associated with one reference plane.

25. The apparatus as recited in claim 24, wherein said one reference plane comprises a longitudinal plane.

26. The apparatus as recited in claim 22, wherein each said estimated relative position comprises an estimated relative longitude position

27. The apparatus as recited in claim 23, wherein said at least one processing unit establishes said initial search order based, at least in part, on a plurality of different orbital planes associated with said plurality of SVs.

28. The apparatus as recited in claim 23, wherein said memory has orbital information stored therein, and said at least one processing unit determines said estimated relative position for each of said plurality of SVs at a reference time using said stored orbital information.

29. The apparatus as recited in claim 28, wherein said reference time is substantially different from an SPS time.

30. The apparatus as recited in claim 28, wherein said reference time is based, at least in part, on said stored orbital information.

31. The apparatus as recited in claim 28, wherein said stored orbital information comprises dated almanac information associated with said SPS.

32. The apparatus as recited in claim 28, wherein said stored orbital information comprises dated ephemeris information associated with said SPS.

33. The apparatus as recited in claim 28, wherein said at least one processing unit determines said estimated relative position for each of said plurality of SVs at said reference time on a reference plane within a modeled reference frame.

34. The apparatus as recited in claim 33, wherein with said modeled reference frame a rotational rate associated with Earth substantially matches an average orbital period associated with at least a portion of said plurality of SVs.

35. The apparatus as recited in claim 33, wherein said at least one processing unit arranges said plurality of SVs into a plurality of SV groups based on said estimated relative positions, and wherein said initial search order specifies an initial sequential searching priority based, at least in part, on said plurality of SV groups.

36. The apparatus as recited in claim 35, wherein at least two of SVs within at least one of said plurality of SV groups are associated with different orbital planes.

37. The apparatus as recited in claim 22, wherein said estimated relative positions of said plurality of SVs are part of a closed circular set of values and said initial search order specifies an initial sequential searching priority based, at least in part, on a binary search of said closed circular set of values.

38. The apparatus as recited in claim 22, wherein said refined search order specifies a refined sequential searching priority based, at least in part, on estimated distances from said first SV to each SV associated with said portion of said plurality of SPS signals that have not been searched for.

39. The apparatus as recited in claim 38, wherein said estimated distances are based, at least in part, on said corresponding estimated relative positions.

40. The apparatus as recited in claim 22, wherein said at least one processing unit determines an SPS time based, at least in part, on said first one of said SPS signals as acquired by said SPS receiver, and update said estimated relative position for each of at least a portion of said plurality of SVs at said SPS time using said stored orbital information.

41. The apparatus as recited in claim 22, wherein said at least one processing unit updates at least a portion of said stored orbital information based, at least in part, on said first one of said plurality of SPS signals as acquired by said SPS receiver.

42. The apparatus as recited in claim 22, wherein said SPS comprises one or more Global Navigation Satellite Systems (GNSSs).

43. The apparatus as recited in claim 22, wherein said apparatus is part of a mobile station.

44. An apparatus comprising:
means for receiving satellite positioning system (SPS) signals
means for specifying an initial search order for a plurality of said SPS signals transmitted from a corresponding plurality of space vehicles (SVs), said initial search order being based, at least in part, on an estimated relative position for each SV;
means for selectively searching for and identifying at least a first one of said plurality of SPS signals in a received RF signal according to said initial search order, said first one of said plurality of SPS signals being transmitted by a first SV;
means for specifying a refined search order comprising at least a portion of said plurality of SPS signals that have not been searched for, said refined search order being based, at least in part, on an estimated relative position of said first SV; and
means for selectively searching for at least a second one of said plurality of SPS signals in said received RF signal according to said refined search order.

45. The apparatus as recited in claim 44, further comprising:
means for establishing at least one of: said initial search order, and/or said refined search order.

46. The apparatus as recited in claim 44, wherein each said estimated relative position comprises an estimated relative position associated with one reference plane.

47. The apparatus as recited in claim 46, wherein said one reference plane comprises a longitudinal plane.

48. The apparatus as recited in claim 44, wherein each said estimated relative position comprises an estimated relative longitude position.

49. The apparatus as recited in claim 45, further comprising:
means for establishing said initial search order based, at least in part, on a plurality of different orbital planes associated with said plurality of SVs.

50. The apparatus as recited in claim 45, further comprising:
means for determining said estimated relative position for each of said plurality of SVs at a reference time using stored orbital information.

51. The apparatus as recited in claim 50, wherein said reference time is substantially different from an SPS time.

52. The apparatus as recited in claim 50, wherein said reference time is based, at least in part, on said stored orbital information.

53. The apparatus as recited in claim 50, wherein said stored orbital information comprises dated almanac information associated with said SPS.

54. The apparatus as recited in claim 50, wherein said stored orbital information comprises dated ephemeris information associated with said SPS.

55. The apparatus as recited in claim 50, further comprising:
means for determining said estimated relative position for each of said plurality of SVs at said reference time on a reference plane within a modeled reference frame.

56. The apparatus as recited in claim 55, wherein with said modeled reference frame a rotational rate associated with Earth substantially matches an average orbital period associated with at least a portion of said plurality of SVs.

57. The apparatus as recited in claim 55, further comprising:
means for arranging said plurality of SVs into a plurality of SV groups based on said estimated relative positions, and wherein said initial search order specifies an initial sequential searching priority based, at least in part, on said plurality of SV groups.

58. The apparatus as recited in claim 57, wherein at least two of SVs within at least one of said plurality of SV groups are associated with different orbital planes.

59. The apparatus as recited in claim 44, wherein said estimated relative positions of said plurality of SVs are part of a closed circular set of values and said initial search order specifies an initial sequential searching priority based, at least in part, on a binary search of said closed circular set of values.

60. The apparatus as recited in claim 44, wherein said refined search order specifies a refined sequential searching priority based, at least in part, on estimated distances from said first SV to each SV associated with said portion of said plurality of SPS signals that have not been searched for.

61. The apparatus as recited in claim 60, wherein said estimated distances are based, at least in part, on said corresponding estimated relative positions.

62. The apparatus as recited in claim 44, further comprising:
means for determining an SPS time based, at least in part, on said first one of said SPS signals once acquired; and
means for updating said estimated relative position for each of at least a portion of said plurality of SVs at said SPS time using said stored orbital information.

63. The apparatus as recited in claim 44, further comprising:
means for updating at least a portion of said stored orbital information based, at least in part, on said first one of said plurality of SPS signals once acquired.

64. The apparatus as recited in claim 44, wherein said SPS comprises one or more Global Navigation Satellite Systems (GNSSs).

65. The apparatus as recited in claim 44, wherein said apparatus is part of a mobile station.

66. An article comprising:
a computer readable medium having computer implementable instructions stored thereon which if implemented by one or more processing units in a specific apparatus that is for use in and/or with a Satellite Positioning System (SPS) receiver operatively enable the specific apparatus to:
access an initial search order for a plurality of SPS signals transmitted from a corresponding plurality of space vehicles (SVs), said initial search order being based, at least in part, on an estimated relative position for each SV;
selectively initiate a search for at least a first one of said plurality of SPS signals in a received RF signal according to said initial search order, and in response to at least identifying at least said first one of said plurality of SPS signals in said received RF signal, said first one of said plurality of SPS signals being transmitted by a first SV;
access a refined search order comprising at least a portion of said plurality of SPS signals that have not been searched for, said refined search order being based, at least in part, on an estimated relative position of said first SV; and
selectively initiate a search for at least a second one of said plurality of SPS signals in said received RF signal according to said refined search order.

67. The apparatus as recited in claim 66, wherein said computer implementable instructions operatively enable the specific apparatus to establish at least one of: said initial search order, and/or said refined search order.

68. The apparatus as recited in claim 66, wherein each said estimated relative position comprises an estimated relative position associated with one reference plane.

69. The apparatus as recited in claim 68, wherein said one reference plane comprises a longitudinal plane.

70. The apparatus as recited in claim 66, wherein each said estimated relative position comprises an estimated relative longitude position

71. The apparatus as recited in claim 67, wherein said computer implementable instructions operatively enable the specific apparatus to establish said initial search order based, at least in part, on a plurality of different orbital planes associated with said plurality of SVs.

72. The apparatus as recited in claim 67, wherein said computer implementable instructions operatively enable the specific apparatus to determine said estimated relative position for each of said plurality of SVs at a reference time using said stored orbital information.

73. The apparatus as recited in claim 72, wherein said reference time is substantially different from an SPS time.

74. The apparatus as recited in claim 72, wherein said reference time is based, at least in part, on said stored orbital information.

75. The apparatus as recited in claim 72, wherein said stored orbital information comprises dated almanac information associated with said SPS.

76. The apparatus as recited in claim 72, wherein said stored orbital information comprises dated ephemeris information associated with said SPS.

77. The apparatus as recited in claim 72, wherein said computer implementable instructions operatively enable the specific apparatus to determine said estimated relative position for each of said plurality of SVs at said reference time on a reference plane within a modeled reference frame.

78. The apparatus as recited in claim 77, wherein with said modeled reference frame a rotational rate associated with Earth substantially matches an average orbital period associated with at least a portion of said plurality of SVs.

79. The apparatus as recited in claim 77, wherein said computer implementable instructions operatively enable the specific apparatus to arrange said plurality of SVs into a plurality of SV groups based on said estimated relative positions, and wherein said initial search order specifies an initial sequential searching priority based, at least in part, on said plurality of SV groups.

80. The apparatus as recited in claim 79, wherein at least two of SVs within at least one of said plurality of SV groups are associated with different orbital planes.

81. The apparatus as recited in claim 66, wherein said estimated relative positions of said plurality of SVs are part of a closed circular set of values and said initial search order specifies an initial sequential searching priority based, at least in part, on a binary search of said closed circular set of values.

82. The apparatus as recited in claim 66, wherein said refined search order specifies a refined sequential searching priority based, at least in part, on estimated distances from said first SV to each SV associated with said portion of said plurality of SPS signals that have not been searched for.

83. The apparatus as recited in claim 82, wherein said estimated distances are based, at least in part, on said corresponding estimated relative positions.

84. The apparatus as recited in claim 66, wherein said computer implementable instructions operatively enable the specific apparatus to determine an SPS time based, at least in part, on said first one of said SPS signals as acquired by said SPS receiver, and update said estimated relative position for each of at least a portion of said plurality of SVs at said SPS time using said stored orbital information.

85. The apparatus as recited in claim 66, wherein said computer implementable instructions operatively enable the specific apparatus to update at least a portion of said stored orbital information based, at least in part, on said first one of said plurality of SPS signals as acquired by said SPS receiver.

86. The apparatus as recited in claim 66, wherein said SPS comprises one or more Global Navigation Satellite Systems (GNSSs).

87. The apparatus as recited in claim 22, wherein said specific apparatus is part of a mobile station.
